(19) United States
(12) Patent Application Publication
(10) Pub. No.: US 2020/0411224 A1
(43) Pub. Date: Dec. 31, 2020

(54) RADIO FREQUENCY TRANSFORMER WINDING COIL STRUCTURE

(71) Applicant: PPC Broadband, Inc., East Syracuse, NY (US)

(72) Inventors: Leon Marketos, Auburn, NY (US); Erdogan Alkan, Manlius, NY (US)

(21) Appl. No.: 17/022,383

(22) Filed: Sep. 16, 2020

Related U.S. Application Data
(63) Continuation of application No. 15/935,458, filed on Mar. 26, 2018, now Pat. No. 10,796,839.
Application No. 15/935,458 is a division of application No. 13/948,315, filed on Jul. 23, 2013, now Pat. No. 9,953,756.
(60) Provisional application No. 61/703,802, filed on Sep. 21, 2012.

(51) Int. Cl. H01F 27/00; H01F 27/255; H01F 27/28; H01F 41/08; H01F 41/02; H01F 41/06

(52) U.S. Cl. CPC H01F 27/006; H01F 27/255; H01F 27/2895; H01F 17/062; H01F 41/0206; H01F 41/06; Y10T 29/49071; H01F 41/08

(57) ABSTRACT

A radio-frequency (RF) transformer includes a ferrite core defining a bore therethrough. The RF transformer also includes a first wire and a second wire. The first and second wires are twisted and form a first exterior half loop at least partially around an exterior of the ferrite core. The first wire, but not the second wire, forms a second exterior half loop at least partially around the exterior of the ferrite core. The ferrite core is configured to provide a primarily magnetic coupling for signals having a frequency that is less than a predetermined threshold. The first and second wires are configured to provide a primarily capacitive coupling for signals having the frequency that is greater than the predetermined threshold.

### CROSS-REFERENCE TO RELATED APPLICATIONS

This application is a continuation of U.S. patent application Ser. No. 15/935,458, filed Mar. 26, 2018, which is a divisional of U.S. patent application Ser. No. 13/948,315, filed Jul. 23, 2013, which claims priority to U.S. Provisional Application Ser. No. 61/703,802 filed on Sep. 21, 2012.

### BACKGROUND

### Technical Field

The present invention relates to RF transformers and, more particularly, an RF transformer with a unique winding structure.

### Related Art

High bandwidth components are useful for a variety of purposes, including operation with a wide spectrum of frequencies. Various materials used in construction of high bandwidth components may result in trade off of various parameters. A trade off of various parameters may cause a decrease in performance. Accordingly, there exists a need in the art to overcome at least some of the deficiencies and limitations described herein above.

### SUMMARY

A radio-frequency (RF) transformer is disclosed. The RF transformer includes a ferrite core defining a bore therethrough. The RF transformer also includes a first wire including a first end portion, a middle portion, and a second end portion. The middle portion of the first wire is between the first and second end portions of the first wire. The RF transformer also includes a second wire including a first end portion, a middle portion, and a second end portion. The middle portion of the second wire is between the first and second end portions of the second wire. The middle portions of the first and second wires are twisted and form a first half loop around an exterior of the ferrite core that is configured to increase a high frequency coupling that varies a loss characteristic and matching for a frequency range from about 5 MHz to about 1700 MHz. The first end portions of the first and second wires form a second half loop through the bore in a first direction. The second end portions of the first and second wires form a third half loop through the bore in a second direction that is opposite to the first direction. The first end portion of the first wire, but not the first end portion of the second wire, forms a fourth half loop around the exterior of the ferrite core. The first end portion of the first wire, but not the first end portion of the second wire, forms a fifth half loop through the bore. The first end portion of the first wire, but not the first end portion of the second wire, forms a sixth half loop around the exterior of the ferrite core. The first end portion of the first wire, but not the first end portion of the second wire, forms a seventh half loop through the bore. The first end portion of the first wire, but not the first end portion of the second wire, forms an eighth half loop around the exterior of the ferrite core. The first end portion of the first wire, but not the first end portion of the second wire, forms a ninth half loop through the bore. The first end portion of the second wire and the second end portion of the first wire are twisted to form a tap. The ferrite core is configured to provide a primarily magnetic coupling for signals having a frequency of less than about 300 MHz. The first and second wires are configured to cause the primarily magnetic coupling to transition to a primarily capacitive coupling for signals having the frequency greater than about 300 MHz.

In another embodiment, the RF transformer includes a ferrite core defining a bore therethrough. The RF transformer also includes a first wire and a second wire. The first and second wires are twisted and form a first exterior half loop at least partially around an exterior of the ferrite core. The first wire, but not the second wire, forms a second exterior half loop at least partially around the exterior of the ferrite core. The ferrite core is configured to provide a primarily magnetic coupling for signals having a frequency that is less than a predetermined threshold. The first and second wires are configured to provide a primarily capacitive coupling for signals having the frequency that is greater than the predetermined threshold.

In another embodiment, the RF transformer includes a first turn portion of first and second wires extending at least partially around an exterior of a ferrite core. The first and second wires are twisted in the first turn portion. The RF transformer also includes a second turn portion of the first and second wires extending through the bore. The RF transformer also includes a third turn portion of the first and second wires extending through the bore. The RF transformer also includes a fourth turn portion of the first wire, but not the second wire, at least partially around the exterior of the ferrite core. The RF transformer is configured to provide primarily a first type of coupling for signals having a frequency that is less than a predetermined threshold. The RF transformer is configured to provide primarily a second type of coupling for signals having the frequency that is greater than the predetermined threshold.

In another embodiment, the RF transformer includes a ferrite core and a plurality of wires for magnetically or capacitively coupling signals based on whether a frequency of the signals is less than or greater than a predetermined frequency threshold. The RF transformer also includes a ferrite core wiring structure having a first half loop wire portion that is configured to increase a high frequency coupling that varies a loss characteristic for a frequency range from about 5 MHz to about 1700 MHz. The ferrite core wiring structure is configured to provide either a primarily capacitive coupling for signals having a first frequency that is greater than a predetermined threshold, or a primarily magnetic coupling for signals having a second frequency that is less than the predetermined threshold.

In another embodiment, the RF transformer includes a ferrite core and a plurality of wires for magnetically or capacitively coupling signals based on whether a frequency of the signals is less than or greater than a predetermined frequency threshold. The RF transformer also includes a wired ferrite core structure having a plurality of half loop wire portions that are each arranged in different configurations so as to provide either a primarily capacitive coupling for signals having a first frequency that is greater than a predetermined threshold, or a primarily magnetic coupling for signals having a second frequency that is less than the predetermined threshold.

The foregoing and other features of the invention will be apparent from the following more particular description of various embodiments of the invention.

### DESCRIPTION OF THE DRAWINGS

The present invention will be more fully understood and appreciated by reading the following Detailed Description in conjunction with the accompanying drawings, in which:

FIG. 1A is a perspective view of a radio frequency (RF) transformer, in accordance with embodiments of the present invention.

FIG. 1B is a side view of the RF transformer of FIG. 1A, in accordance with embodiments of the present invention.

FIG. 1C is a top view of the RF transformer of FIG. 1A, in accordance with embodiments of the present invention.

FIG. 2A is a side view of a multicore RF transformer, in accordance with embodiments of the present invention.

FIG. 2B is a perspective view of a multiple multicore RF transformers, in accordance with embodiments of the present invention.

FIG. 3 is a perspective view of a multicore RF transformer connected to another multicore RF transformer, in accordance with embodiments of the present invention.

FIG. 4 is a perspective view of an alternative multicore RF transformer, in accordance with embodiments of the present invention.

FIG. 5 is a side view of a twisted wire pair, in accordance with embodiments of the present invention.

FIG. 6A is a side view of an RF transformer comprising a twisted wire pair, in accordance with embodiments of the present invention.

FIG. 6B is a side view of an RF transformer comprising multiple twisted wire pairs, in accordance with embodiments of the present invention.

FIGS. 7A-7J illustrate a process for building the RF transformer of FIG. 6B, in accordance with embodiments of the present invention.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., which are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a,” “an,” and “the” include plural referents, unless the context clearly dictates otherwise.

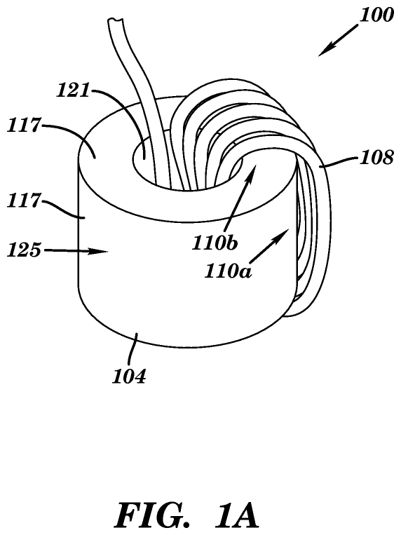

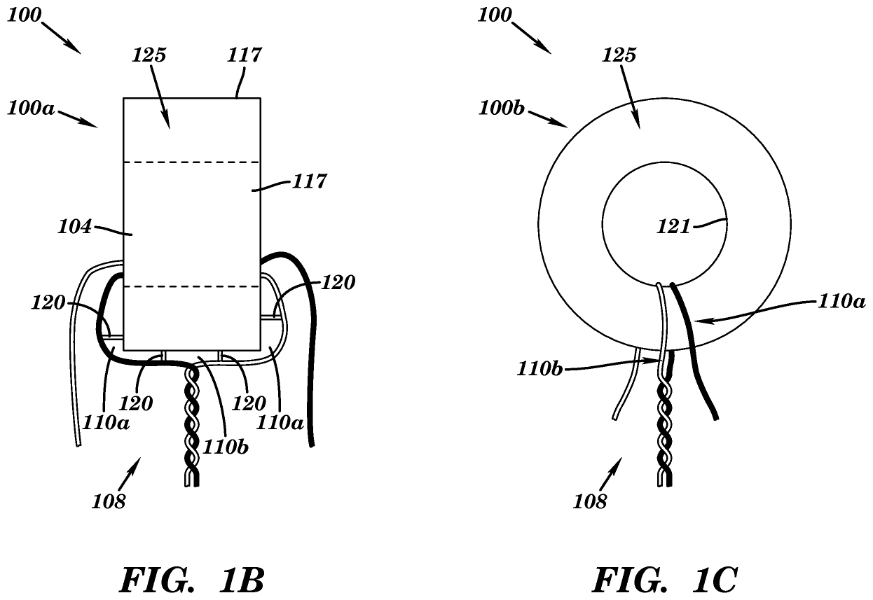

Referring now to the drawings, wherein like reference numerals refer to like parts throughout, there is seen in FIG. 1A a perspective view of a radio frequency (RF) transformer 100, in accordance with embodiments of the present invention. RF transformer 100 may include a ferrite core 104 and a winding (coil) structure 108. Ferrite core 104 may include multiple ferrite material types arranged in a non-uniform manner. Winding structure 108 is in electrical contact with interior surface 121 of ferrite core 104. RF transformer 100 may be formed such that air gaps 110a and 110b are formed between winding structure 108 and an exterior surface 117 of ferrite core 104. Air gaps 110a and 110b essentially electrically and physically space winding structure 108 from exterior surface 117 of ferrite core 104. Additionally, spacers (e.g., spacers 120 in FIG. 1B as described, infra) may be strategically placed between winding structure 108 and ferrite core 104. Spacers 120 essentially electrically and physically space winding structure 108 from exterior surface 117 of ferrite core 104. Alternatively, ferrite core 104 may include an electrically insulative material 125 formed over an exterior surface 117 of ferrite core 104. The insulative material 125 is not formed over interior surface 121 of the ferrite core 104. Electrically insulative material 125 electrically and physically spaces winding structure 108 from exterior surface 117 of ferrite core 104. Winding structure 108 includes turns of a relatively fine gauge insulated wire (e.g., copper) installed on ferrite core 104 to form a group of windings of a specified number of turns and orientation. RF transformer 100 enables a unique combination of performance parameters such as, inter alia:
1. Conveyance of RF signals along an intended path (i.e., insertion loss).
2. A match to system impedance (i.e., return loss). In specific embodiments, a minimization of signal leakage among ports (i.e., isolation).
3. A maintenance of proper operation at low frequencies and cold temperatures (i.e., significantly affected by a specific ferrite material used).
4. Ultimate operation at high frequencies (i.e., significantly affected by specific ferrite material used and a winding arrangement/parasitic s).
5. An ability to withstand high signal levels without producing unwanted signals (i.e., intermodulation).
6. An ability to withstand high magnetic excitation without degraded performance (surge).

RF transformer 100 enables manipulation of winding structure 108 with respect to ferrite core 104. At relatively low frequencies, a coupling of energy is magnetic and facilitated by the ferrite (of ferrite core 104). As a frequency rises through approximately 300 MHz, an effectiveness of the ferrite magnetic coupling decreases and a dominant coupling occurs via a capacitive (proximity) coupling among the windings. At the higher frequencies (i.e., greater than about 300 MHz), presence of the ferrite may add to parasitic losses. RF transformer 100 provides an ability to blend multiple types of ferrite materials in order to manage frequency performance at high and low frequencies. Additionally, RF transformer 100 provides an ability to generate portions of winding structure 108 that are not closely coupled (i.e., spaced away from) to ferrite core 104. Generating portions of winding structure 108 that are not closely coupled (i.e., spaced away from) to ferrite core 104 may be accomplished by using individual pieces of material (e.g., ferrous or non-ferrous, conductive or nonconductive) such as spacers situated between ferrite core 104 and winding structure 108 and/or within winding structure 108.

Referring further to FIG. 1B, there is seen a side view 100a of RF transformer 100 of FIG. 1A, in accordance with embodiments of the present invention. FIG. 1B illustrates spacers 120 used to separate winding structure 108 from exterior surface 117 of core structure 104. Spacers 120 may comprise any type of operable spacers that include any size, shape, and/or material. For example, spacers 120 may comprise plastic, fiberglass, an insulator material, a dielectric material, etc.

Referring further to FIG. 1C, there is seen a top view 100b of RF transformer 100 of FIG. 1A, in accordance with embodiments of the present invention.

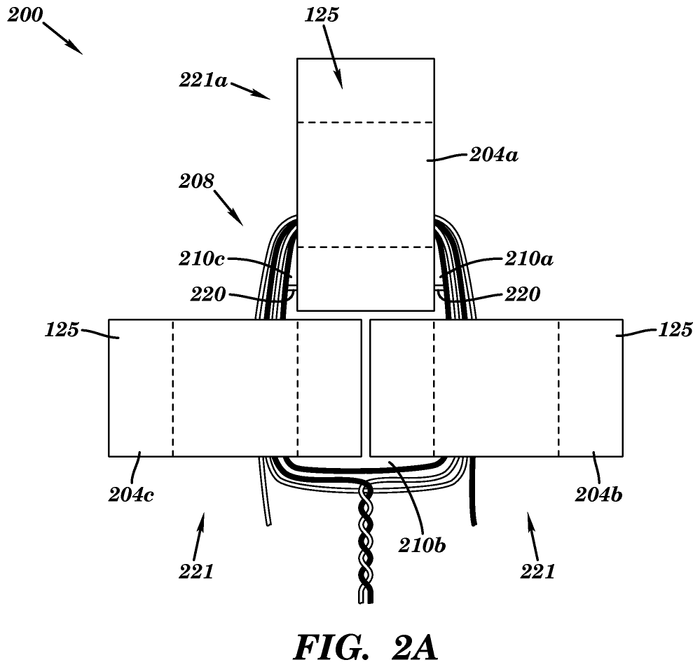

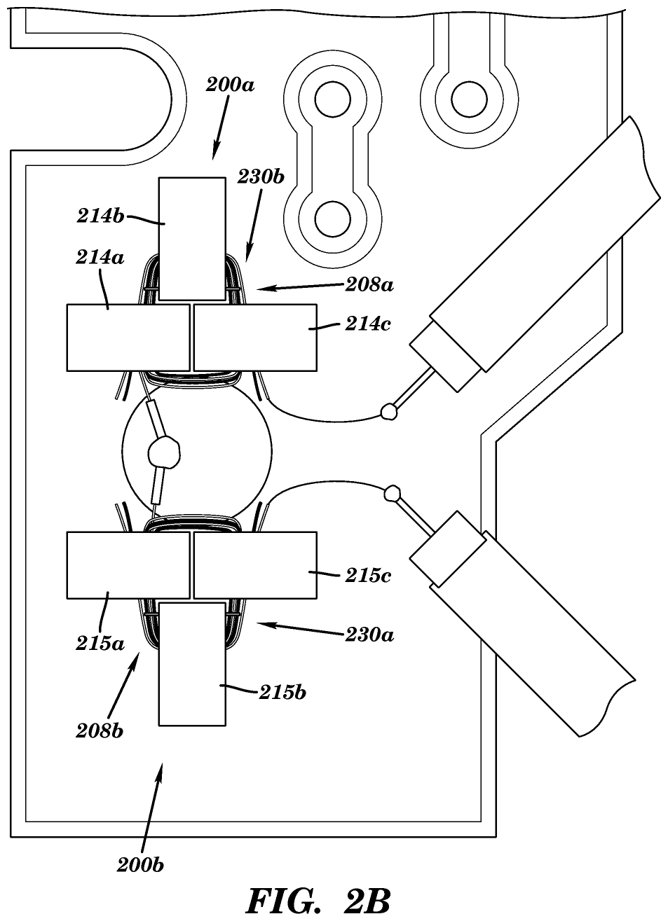

Referring further to FIG. 2A, there is seen a side view of a multicore RF transformer 200, in accordance with embodiments of the present invention. Multicore RF transformer 200 comprises multiple ferrite cores 204a, 204b, and 204c and a winding (coil) structure 208 strategically formed around ferrite cores 204a, 204b, and 204c. Ferrite cores 204a, 204b, and 204c may each include multiple ferrite material types arranged in a non-uniform manner. Each of ferrite cores 204a, 204b, and 204c may comprise a same size, shape, and material. Alternatively, each of ferrite cores 204a, 204b, and 204c may comprise a different size, shape, and/or material. Winding structure 208 is in electrical contact with interior surfaces of ferrite cores 204a, 204b, and 204c. Multicore RF transformer 200 may be formed such that air gaps 210a, 210b, and 210c are formed between winding structure 208 and exterior surfaces of ferrite cores 204a, 204b, and 204c. Air gaps 210a, 210b, and 210c essentially electrically and physically space winding structure 208 from exterior surfaces of ferrite cores 204a, 204b, and 204c. Additionally, spacers 220 may be strategically placed between winding structure 208 and ferrite cores 204a, 204b, and 204c. The spacers essentially electrically and physically space winding structure 208 from exterior surfaces of ferrite cores 204a, 204b, and 204c. Alternatively and/or additionally, ferrite cores 204a, 204b, and 204c may each include an electrically insulative material 125 formed over exterior surfaces of ferrite cores 204a, 204b, and 204c. The insulative material 125 is not formed over interior surfaces 221 of ferrite cores 204a, 204b, and 204c. Electrically insulative material 125 electrically and physically spaces winding structure 208 from exterior surfaces of ferrite cores 204a, 204b, and 204c.

The use of multiple ferrite cores (e.g., ferrite cores 204a, 204b, and 204c) allows potential selection of multiple different types of ferrite thereby allowing a designer additional flexibility to blend desirable properties of different ferrite material types. The use of multiple ferrite cores of a same type of ferrite material may additionally segmenting of a ferrite medium. Additionally, multicore RF transformer 200 enables an overall winding structure comprising a unique shape offering enhanced parasitics thereby allowing a high frequency performance. Generating portions of winding structure 208 that are not closely coupled (i.e., spaced away from) to ferrite cores 204a, 204b, and 204c may be accomplished by selecting different ferrite sizes or shapes and/or arranging ferrite cores 204a, 204b, and 204c in such a way as to create gaps between winding structure 208 and ferrite cores 204a, 204b, and 204c at specified areas.

Referring further to FIG. 2B, there is seen a perspective view of a multicore RF transformer 200a connected to a multicore RF transformer 200b, in accordance with embodiments of the present invention. Multicore RF transformer 200a is electrically and physically connected to a multicore RF transformer 200b. Multicore RF transformer 200a comprises multiple ferrite cores 214a, 214b, and 214c and a winding (coil) structure 208a strategically formed around ferrite cores 214a, 214b, and 214c. Ferrite cores 214a, 214b, and 214c may each include multiple ferrite material types arranged in a non-uniform manner. Each of ferrite cores 214a, 214b, and 214c may comprise a same size, shape, and material. Alternatively, each of ferrite cores 214a, 214b, and 214c may comprise a different size, shape, and/or material. Winding structure 208a is in electrical contact with interior surfaces of ferrite cores 214a, 214b, and 214c. Multicore RF transformer 200 may be formed such that air gaps 230a are formed between winding structure 208a and exterior surfaces of ferrite cores 214a, 214b, and 214c. Air gaps 230a essentially electrically and physically space winding structure 208a from exterior surfaces of ferrite cores 214a, 214b, and 214c. Additionally, spacers (e.g., spacers 220 of FIG. 2A) may be strategically placed between winding structure 208a and ferrite cores 204a, 204b, and 204c. The spacers essentially electrically and physically space winding structure 208a from exterior surfaces of ferrite cores 214a, 214b, and 214c. Alternatively and/or additionally, ferrite cores 214a, 214b, and 214c may each include an electrically insulative material formed over exterior surfaces of ferrite cores 214a, 214b, and 214c. The insulative material is not formed over interior surfaces of ferrite cores 214a, 214b, and 214c. The electrically insulative material electrically and physically spaces winding structure 208a from exterior surfaces of ferrite cores 214a, 214b, and 214c. Multicore RF transformer 200b comprises multiple ferrite cores 215a, 215b, and 215c and a winding (coil) structure 208b strategically formed around ferrite cores 215a, 215b, and 215c. Ferrite 215a, 215b, and 215c may each include multiple ferrite material types arranged in a non-uniform manner. Each of ferrite cores 215a, 215b, and 215c may comprise a same size, shape, and material. Alternatively, each of ferrite cores 215a, 215b, and 215c may comprise a different size, shape, and/or material. Winding structure 208b is in electrical contact with interior surfaces of ferrite cores 215a, 215b, and 215c. Multicore RF transformer 200b may be formed such that air gaps 230b are formed between winding structure 208b and exterior surfaces of ferrite cores 215a, 215b, and 215c. Air gaps 230b essentially electrically and physically space winding structure 208b from exterior surfaces of ferrite cores 215a, 215b, and 215c. Additionally, spacers (e.g., spacers 220 of FIG. 2A) may be strategically placed between winding structure 208b and ferrite cores 215a, 215b, and 215c. The spacers essentially electrically and physically space winding structure 208b from exterior surfaces of ferrite cores 215a, 215b, and 215c. Alternatively and/or additionally, ferrite cores 215a, 215b, and 215c may each include an electrically insulative material formed over exterior surfaces of ferrite cores 215a, 215b, and 215c. The insulative material is not formed over interior surfaces of ferrite cores 215a, 215b, and 215c. The electrically insulative material electrically and physically spaces winding structure 208b from exterior surfaces of ferrite cores 215a, 215b, and 215c.

Referring further to FIG. 3, there is seen a perspective view of a multicore RF transformer 300a connected to a multicore RF transformer 300b, in accordance with embodiments of the present invention. Multicore RF transformer 300a is electrically and physically connected to a multicore RF transformer 300b.

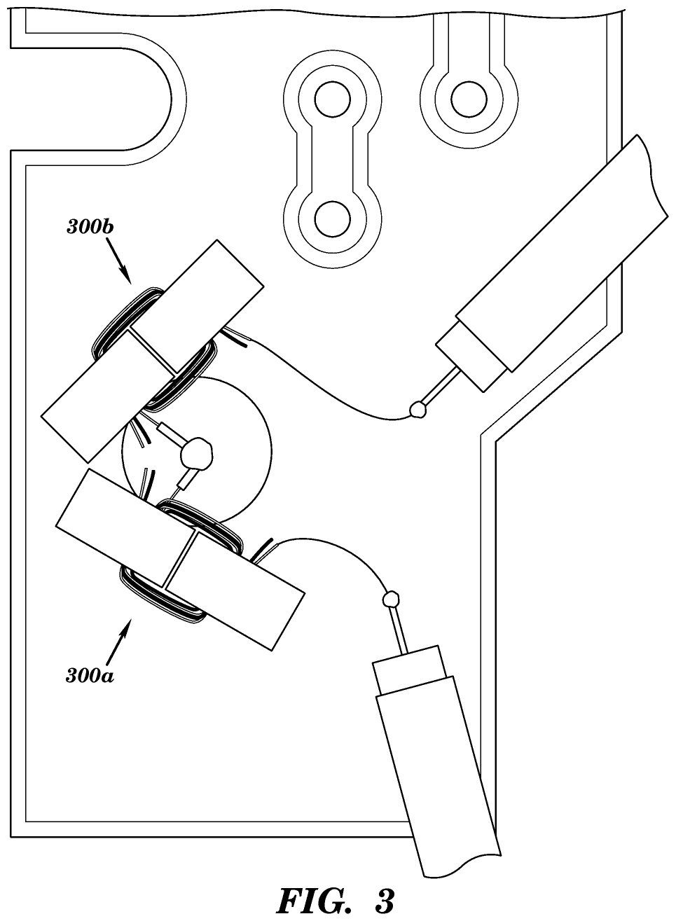

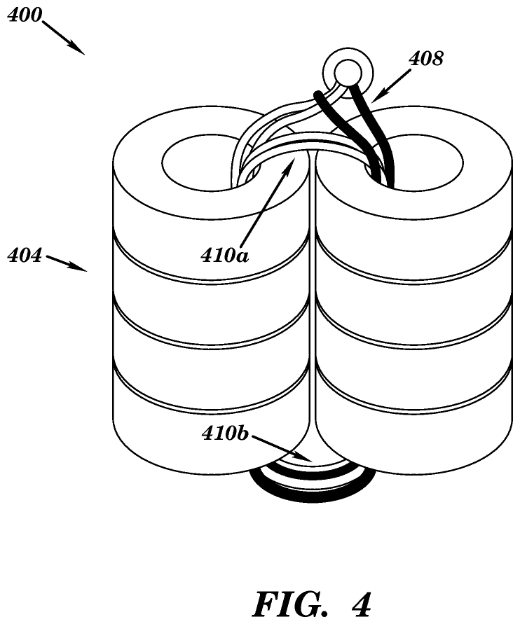

Referring further to FIG. 4, there is seen a perspective view of a multicore RF transformer 400, in accordance with embodiments of the present invention. Multicore RF transformer 400 comprises multiple (i.e., eight) ferrite cores 404 and a winding (coil) structure 408 strategically formed around ferrite cores 404. Ferrite cores 404 may each include multiple ferrite material types arranged in a non-uniform manner. Each of ferrite cores 404 may comprise a same size, shape, and material. Alternatively, each of ferrite cores 404 may comprise a different size, shape, and/or material. Winding structure 408 is in electrical contact with interior surfaces of ferrite cores 404. Multicore RF transformer 400 may be formed such that air gaps 410a and 410b are formed between winding structure 408 and exterior surfaces of ferrite cores 404. Air gaps 410a and 410b essentially electrically and physically space winding structure 408 from exterior surfaces of ferrite cores 404. Additionally, spacers (e.g., spacers of FIG. 220 of FIG. 2A) may be used to electrically and physically space winding structure 408 from exterior surfaces of ferrite cores 404.

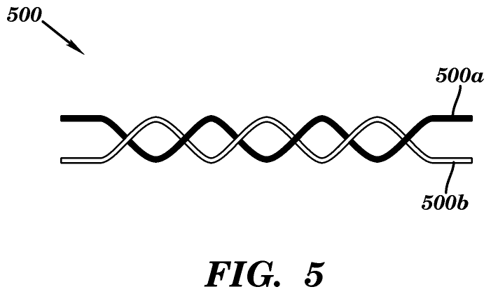

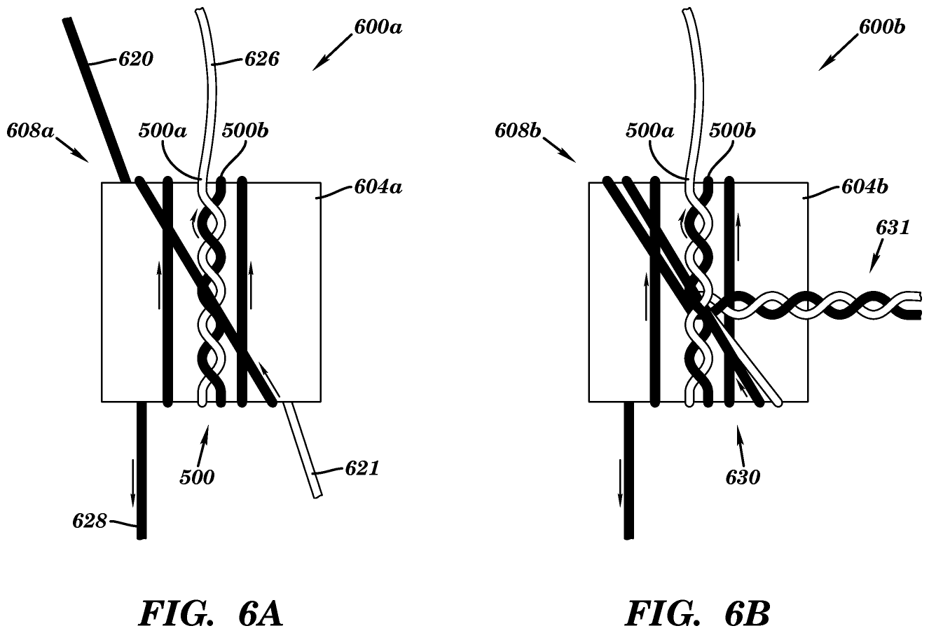

Referring further to FIG. 5, there is seen a side view of a twisted wire pair 500 used in a winding structure for an RF transformer, in accordance with embodiments of the present invention. Twisted wire pair 500 comprises a center twisted winding of a matching transformer. Twisted wire pair 500 of FIG. 5 may be used for RF transformer 600a of FIG. 6A and/or RF transformer 600b of FIG. 6B as described, infra. Twisted wire pair 500 comprises a wire portion 500a twisted with a wire portion 500b and depending on a performance of parameters (such as, inter alia, isolation, insertion loss, return loss, etc.), a number of twists may be adjusted. Twisted wire pair 500 of FIG. 5 may be placed as a middle turn of a winding structure on a ferrite core (i.e., as illustrated in FIGS. 6A and 6B).

Referring further to FIG. 6A, there is seen a side view of an RF transformer 600a comprising a winding structure 608a, in accordance with embodiments of the present invention. RF transformer 600a (i.e., matching transformer) illustrates common leads (i.e., wires 620 and 621) before twisting the common leads together as illustrated in FIG. 6B, infra. RF transformer 600a comprises winding structure 608a formed around a ferrite core 604a. Ferrite core 604a may include multiple ferrite material types arranged in a non-uniform manner. Twisted wire pair 500 is formed by twisting wire portion 500b of wire 620 with wire portion 500a of wire 621. Wire 626 comprises an input wire and wire 628 comprises a ground wire. An orientation of multiple turns (i.e., of twisted wire pairs) on ferrite core 604a of the matching transformer enables specified performance parameters. For example, as a frequency rises at relatively low frequencies, a coupling is generally magnetic and facilitated by a ferrite material. As frequency rises through approximately 300 MHz, an effectiveness of the ferrite magnetic coupling decreases and a dominant coupling occurs via capacitive (proximity) coupling among the windings themselves.

Referring further to FIG. 6B, there is seen a side view of an RF transformer 600b comprising a winding structure 608b, in accordance with embodiments of the present invention. FIG. 6B shows a common end twisted wire pair 631 as a final look of the matching transformer. Twisted wire pair 631 includes tinned ends in order to removed insulation from the wires. Therefore, the tinned become a connection point between a matching transformer and a splitting transformer. Winding numbers show the orientation of the windings that also results in a broadband response. RF transformer 600b comprises winding structure 608b formed around a ferrite core 604b. Ferrite core 604b may include multiple ferrite material types arranged in a non-uniform manner. Winding structure 608b comprises a twisted wire pair 630 and 631 (i.e., common leads such as wires 620 and 621 twisted together) for a matching transformer. Providing twisted wire pairs at a center of a winding scheme increases a high frequency coupling to result in preferred loss characteristics and matching for a broadband spectrum from about 5 MHz to about 1700 MHz.

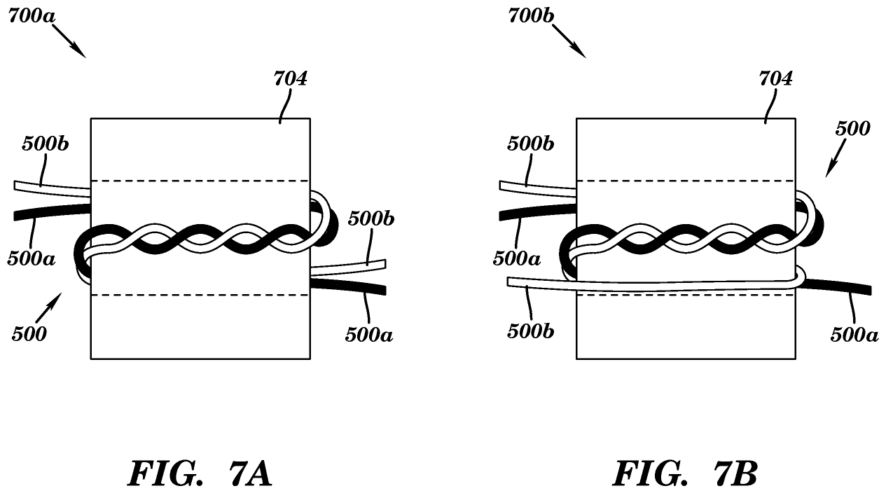

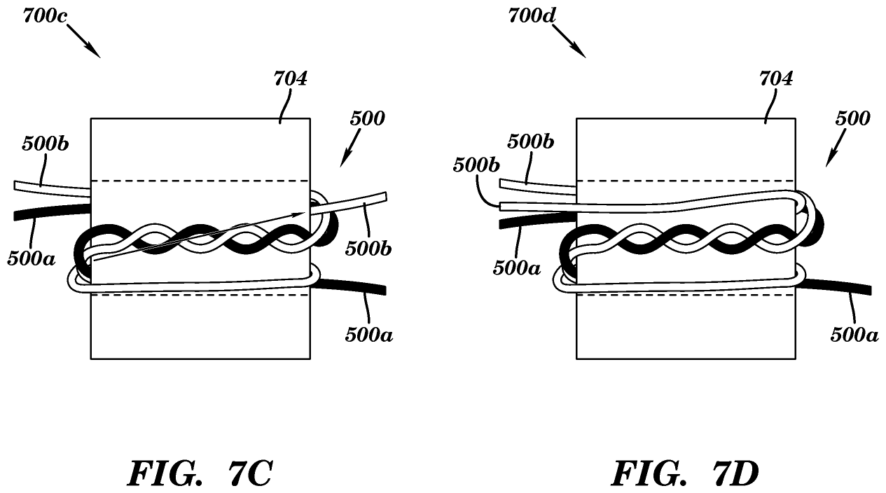

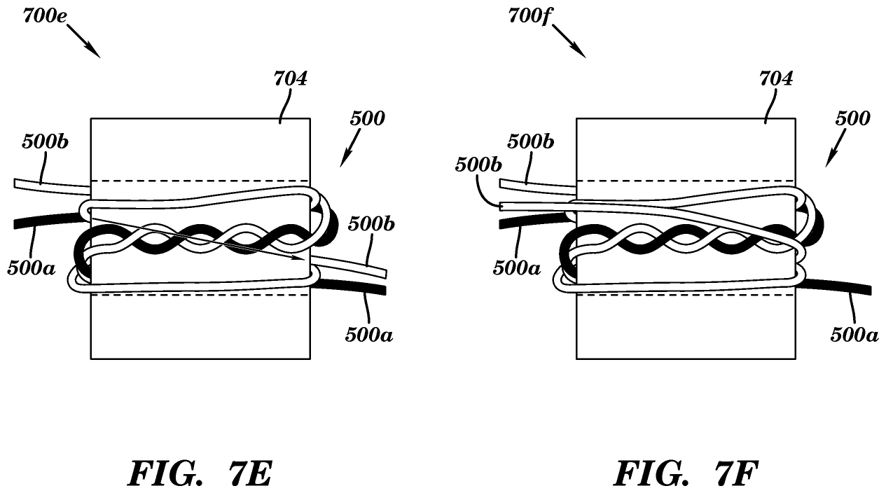

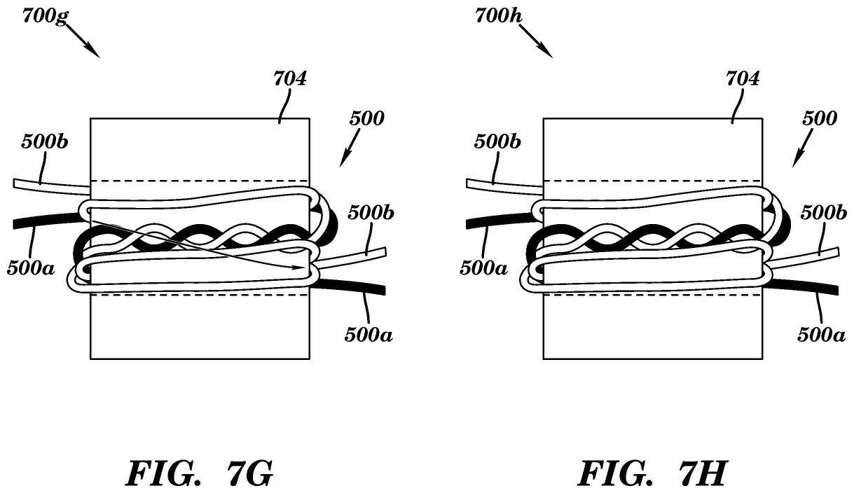

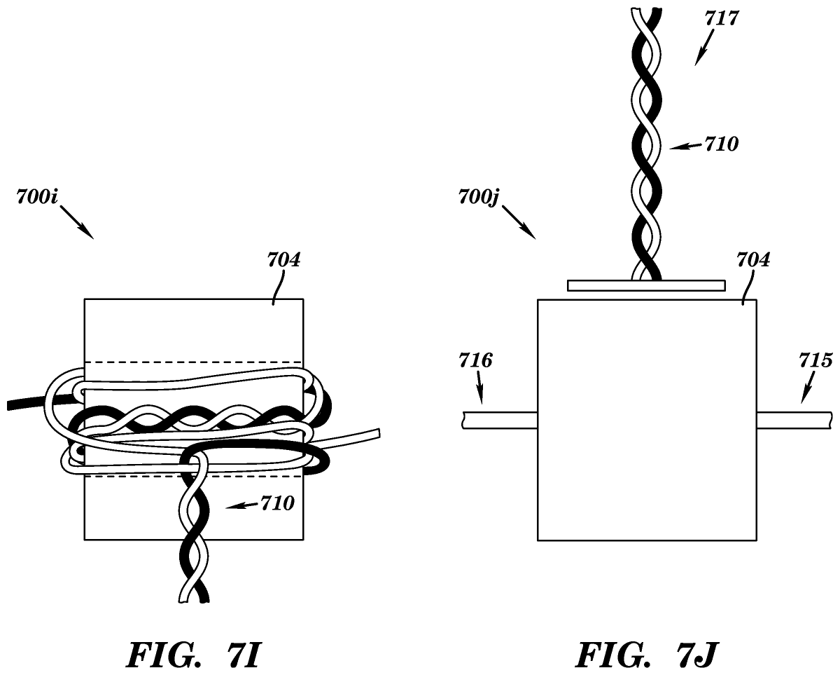

Referring further to FIGS. 7A-7J, there is seen a process for building RF transformer 600b (i.e., using side views) of FIG. 6B, in accordance with embodiments of the present invention.

FIG. 7A illustrates a first step 700a for forming RF transformer 600b comprising twisted wire pair 500 (i.e., described in FIG. 5 and including a wire portion 500a twisted with a wire portion 500b) formed around ferrite core 704.

FIG. 7B illustrates a second step 700b for forming RF transformer 600b. The second step 700b includes forming another turn of wire portion 500b through a center of and around ferrite core 704.

FIG. 7C illustrates a third step 700c for forming RF transformer 600b. The third step 700c includes forming another turn of wire portion 500b through the center of ferrite core 704.

FIG. 7D illustrates a fourth step 700d for forming RF transformer 600b. The fourth step 700d includes forming wire portion 500b across an outside portion of ferrite core 704.

FIG. 7E illustrates a fifth step 700e for forming RF transformer 600b. The fifth step 700e includes forming another turn of wire portion 500b through the center of ferrite core 704.

FIG. 7F illustrates a sixth step 700f for forming RF transformer 600b. The sixth step 700f includes forming another turn of wire portion 500b across an outside portion of ferrite core 704 and across twisted wire pair 500.

FIG. 7G illustrates a seventh step 700g for forming RF transformer 600b. The seventh step 700g includes forming another turn of wire portion 500b through the center of ferrite core 704.

FIG. 7H illustrates an eighth step 700h for forming RF transformer 600b. The eighth step 700h includes twisting wire portion 500a with wire portion 500b.

FIG. 7I illustrates a ninth step 700i for forming RF transformer 600b. The ninth step 700i includes twisting wire portion forming a tap portion 710.

FIG. 7J illustrates a tenth step 700j for forming RF transformer 600b. The tenth step includes tinning all exposed leads 715, 716, and 717.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

1. A radio-frequency (RF) transformer, comprising:
a ferrite core defining a bore therethrough;
a first wire comprising a first end portion, a middle portion, and a second end portion, the middle portion of the first wire being between the first and second end portions of the first wire;
a second wire comprising a first end portion, a middle portion, and a second end portion, the middle portion of the second wire being between the first and second end portions of the second wire;
wherein the middle portions of the first and second wires are twisted and form a first half loop around an exterior of the ferrite core that is configured to increase a high frequency coupling that varies a loss characteristic and matching for a frequency range from about 5 MHz to about 1700 MHz;
wherein the first end portions of the first and second wires form a second half loop through the bore in a first direction;
wherein the second end portions of the first and second wires form a third half loop through the bore in a second direction that is opposite to the first direction;
wherein the first end portion of the first wire, but not the first end portion of the second wire, forms a fourth half loop around the exterior of the ferrite core;
wherein the first end portion of the first wire, but not the first end portion of the second wire, forms a fifth half loop through the bore;
wherein the first end portion of the first wire, but not the first end portion of the second wire, forms a sixth half loop around the exterior of the ferrite core;
wherein the first end portion of the first wire, but not the first end portion of the second wire, forms a seventh half loop through the bore;
wherein the first end portion of the first wire, but not the first end portion of the second wire, forms an eighth half loop around the exterior of the ferrite core;
wherein the first end portion of the first wire, but not the first end portion of the second wire, forms a ninth half loop through the bore;
wherein the first end portion of the second wire and the second end portion of the first wire are twisted to form a tap;
wherein the ferrite core is configured to provide a primarily magnetic coupling for signals having a frequency of less than about 300 MHz; and
wherein the first and second wires are configured to cause the primarily magnetic coupling to transition to a primarily capacitive coupling for signals having the frequency greater than about 300 MHz.

2. The RF transformer of claim 1, wherein the first end portions of the first and second wires that form the second half loop are not twisted.

3. The RF transformer of claim 2, wherein the second end portions of the first and second wires that form the third half loop are not twisted.

4. The RF transformer of claim 1, wherein the first half loop is positioned between the fourth half loop and the sixth half loop.

5. The RF transformer of claim 1, wherein the eighth half loop crosses over the first half loop.

6. A radio-frequency (RF) transformer, comprising:
a ferrite core defining a bore therethrough;
a first wire;
a second wire;
wherein the first and second wires are twisted and form a first exterior half loop at least partially around an exterior of the ferrite core;
wherein the first wire, but not the second wire, forms a second exterior half loop at least partially around the exterior of the ferrite core;
wherein the ferrite core is configured to provide a primarily magnetic coupling for signals having a frequency that is less than a predetermined threshold; and
wherein the first and second wires are configured to provide a primarily capacitive coupling for signals having the frequency that is greater than the predetermined threshold.

7. The RF transformer of claim 6, wherein the first exterior half loop is configured to increase a high frequency coupling that varies a loss characteristic and matching for a frequency range from about 5 MHz to about 1700 MHz.

8. The RF transformer of claim 6, wherein the first and second wires form a first interior half loop through the bore in a first direction, wherein the first and second wires form a second interior half loop through the bore in a second direction that is opposite to the first direction, and wherein the first wire, but not the second wire, forms a third interior half loop through the bore.

9. The RF transformer of claim 8, wherein the first wire, but not the second wire, forms a third exterior half loop around the exterior of the ferrite core, and wherein the first exterior half loop is positioned between the second exterior half loop and the third exterior half loop.

10. The RF transformer of claim 9, wherein the first wire, but not the second wire, forms a fourth interior half loop through the bore, wherein the first wire, but not the second wire, forms a fourth exterior half loop around the exterior of the ferrite core, and wherein the fourth exterior half loop crosses over the first exterior half loop.

11. A radio-frequency (RF) transformer, comprising:
a first turn portion of first and second wires extending at least partially around an exterior of a ferrite core, wherein the first and second wires are twisted in the first turn portion;
a second turn portion of the first and second wires extending through the bore;
a third turn portion of the first and second wires extending through the bore;
a fourth turn portion of the first wire, but not the second wire, at least partially around the exterior of the ferrite core;
wherein the RF transformer is configured to provide primarily a first type of coupling for signals having a frequency that is less than a predetermined threshold; and
wherein the RF transformer is configured to provide primarily a second type of coupling for signals having the frequency that is greater than the predetermined threshold.

12. The RF transformer of claim 11, further comprising a fifth turn portion of the first wire, but not the second wire, through the bore.

13. The RF transformer of claim 12, further comprising a sixth turn portion of the first wire, but not the second wire, around the exterior of the ferrite core.

14. The RF transformer of claim 13, wherein the first turn portion is positioned at least partially between the fourth turn portion and the sixth turn portion.

15. The RF transformer of claim 14, further comprising:
a seventh turn portion of the first wire, but not the second wire, through the bore, and
an eighth turn portion of the first wire, but not the second wire, around the exterior of the ferrite core.

16. The RF transformer of claim 15, wherein the eighth turn portion crosses over the first turn portion.

17. The RF transformer of claim 11, wherein the first wire crosses over the first turn portion.

18. The RF transformer of claim 17, wherein the second wire does not cross over the first turn portion.

19. The RF transformer of claim 11, wherein the first type of coupling comprises magnetic coupling, and wherein the second type of coupling comprises capacitive coupling.

20. The RF transformer of claim 19, wherein the predetermined threshold is about 300 MHz.

21. A radio-frequency (RF) transformer having a ferrite core and a plurality of wires for magnetically or capacitively coupling signals based on whether a frequency of the signals is less than or greater than a predetermined frequency threshold, the RF transformer comprising:
a ferrite core wiring structure having a first half loop wire portion that is configured to increase a high frequency coupling that varies a loss characteristic for a frequency range from about 5 MHz to about 1700 MHz; and
wherein the ferrite core wiring structure is configured to provide either a primarily capacitive coupling for signals having a first frequency that is greater than a predetermined threshold, or a primarily magnetic coupling for signals having a second frequency that is less than the predetermined threshold.

22. The RF transformer of claim 21, wherein the ferrite core defines a bore.

23. The RF transformer of claim 21, wherein the ferrite core winding structure comprises a first wire and a second wire, and wherein the first half loop wire portion comprises a twisted portion of the first wire and the second wire.

24. The RF transformer of claim 23, wherein the first half loop wire portion is configured to extend at least partially around an exterior of the ferrite core so as to increase the high frequency coupling that varies the loss characteristic for the frequency range from about 5 MHz to about 1700 MHz.

25. The RF transformer of claim 21, wherein the ferrite core winding structure comprises a first wire and a second wire, wherein the first wire and the second wire form a second half loop wire portion, and wherein the second half loop wire portion is configured to extend through a bore of the ferrite core in a first direction.

26. The RF transformer of claim 25, wherein the first wire and the second wire form a third half loop wire portion.

27. The RF transformer of claim 26, wherein the third half loop wire portion is configured to extend through the bore of the ferrite core in a second direction that is different than the first direction.

28. The RF transformer of claim 21, wherein the ferrite core winding structure comprises a first wire and a second wire, and wherein a second half loop wire portion is formed by the first wire, but not the second wire.

29. The RF transformer of claim 28, wherein the second half loop wire portion is configured to extend at least partially around an exterior of the ferrite core.

30. The RF transformer of claim 21, wherein the predetermined threshold is about 300 MHz.

31. A radio-frequency (RF) transformer having a ferrite core and a plurality of wires for magnetically or capacitively coupling signals based on whether a frequency of the signals is less than or greater than a predetermined frequency threshold, the RF transformer comprising:
a wired ferrite core structure having a plurality of half loop wire portions that are each arranged in different configurations so as to provide either a primarily capacitive coupling for signals having a first frequency that is greater than a predetermined threshold, or a primarily magnetic coupling for signals having a second frequency that is less than the predetermined threshold.

32. The RF transformer of claim 31, wherein the ferrite core includes a bore.

33. The RF transformer of claim 31, wherein the wired ferrite core structure includes a first wire and a second wire, and wherein portions of the first and second wires are twisted so as to form a first half loop wire portion.

34. The RF transformer of claim 33, wherein the first half loop wire portion is configured to extend at least partially around an exterior of a ferrite core so as to increase a high frequency coupling that varies a loss characteristic for a frequency range from about 5 MHz to about 1700 MHz.

35. The RF transformer of claim 33, wherein the wired ferrite core structure includes a second half loop wire portion, and wherein the second half loop wire portion is configured to extend through a bore of a ferrite core in a first direction.

36. The RF transformer of claim 35, wherein the wired ferrite core structure includes a third half loop wire portion, and wherein the third half loop wire portion is configured to extend through the bore of the ferrite core in a second direction that is different from the first direction.

37. The RF transformer of claim 36, wherein the second direction is opposite to the first direction.

38. The RF transformer of claim 31, wherein the wired ferrite core structure includes a first wire and a second wire, and wherein the first wire, but not the second wire, forms a first half loop wire portion.

39. The RF transformer of claim 38, wherein the first half loop wire portion is configured to extend at least partially around an exterior of a ferrite core.

40. The RF transformer of claim 31, wherein the predetermined threshold is about 300 MHz.
